(19) United States
(12) Patent Application Publication
(10) Pub. No.: US 2005/0133300 A1
(43) Pub. Date: Jun. 23, 2005

(54) Device for establishing noise in a motor vehicle

(76) Inventors: Marcus Hofmann, Stuttgart (DE); Roudolf Starobinski, Hamburg (DE)

Correspondence Address: KLAUS J. BACH, 4407 TWIN OAKS DRIVE, MURRYSVILLE, PA, 15668, US

(21) Appl. No.: 10/998,359

(22) Filed: Nov. 27, 2004

Related U.S. Application Data
(63) Continuation-in-part of application No. PCT/EP03/03479, filed on Apr. 3, 2003.

(30) Foreign Application Priority Data
May 29, 2002 (DE) 102 23 871.5

(51) Int. Cl. F02M 35/00; F01N 1/02; F01N 1/08

(52) U.S. Cl. 181/250; 181/273; 181/276

(57) ABSTRACT

In a device for establishing noise in a motor vehicle with a housing, which is divided by at least one sound transmission device into at least two spaces, of which one space is in connection via an inlet line with a gas-carrying part of an internal combustion engine of the vehicle and the other space is acoustically coupled, by means of an outlet line, to an interior space of the vehicle and/or to the space surrounding the vehicle. The outlet line has at least one branch area, from which at least two branch lines extend to different locations in the interior space of the vehicle and/or the space surrounding the vehicle.

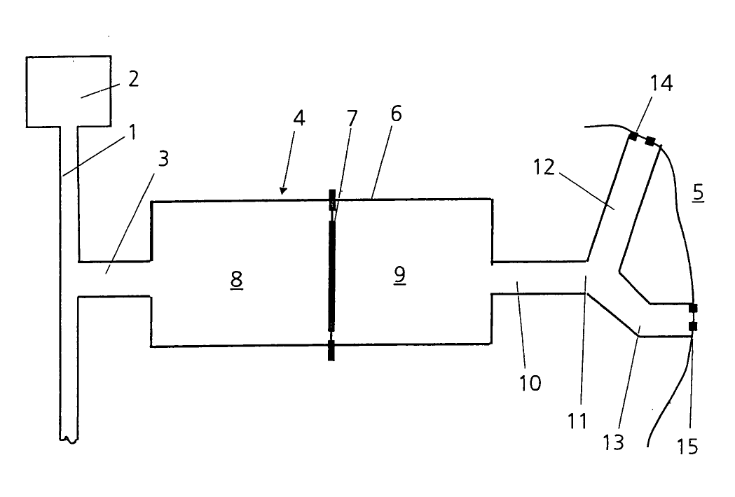

This is a Continuation-In-Part application of international application PCT/EP03/03479 filed Apr. 3, 2003 and claiming the priority of German application 102 23 871.5 filed May 29, 2002.

### BACKGROUND OF THE INVENTION

The invention relates to a device for establishing noise in a motor vehicle including a housing which is divided by a sound transmission structure into at least two spaces, one being in communication with a gas carrying part of an internal combustion engine of the vehicle and the other being acoustically coupled to the vehicle interior.

Such a device is known, for example, from DE 44 35 296 A1. Such devices are intended to transmit the noises produced by the internal combustion engine more intensely to the driver of the motor vehicle, in particular during acceleration, in order, on the one hand, to provide for a more intensive driving experience and, on the other hand, to pass on more information concerning the load state of the engine to the driver.

The disadvantages of this known device, however, are its relatively low efficiency and the very inflexible transmission characteristics.

DE 100 42 012 A1 attempts to improve the efficiency of such a device. However, an optimum solution is still not offered there either, in particular with regard to more flexible transmission characteristics.

It is therefore the object of the present invention to provide a device for establishing noise in a motor vehicle wherein the noise produced by the internal combustion engine can be transmitted by simple means, with improved noise transmission characteristics.

### SUMMARY OF THE INVENTION

In a device for establishing noise in a motor vehicle with a housing, which is divided by at least one sound transmission device into at least two spaces, one space is in connection via an inlet line with a gas-carrying part of an internal combustion engine of the vehicle and the other space is acoustically coupled, by means of an outlet line, to an interior space of the vehicle and/or to the space surrounding the vehicle. The outlet line has at least one branch area, from which at least two branch lines extend to different locations in the interior space and/or the space surrounding the vehicle.

The branching of the outlet line, with at least two branch lines extending from it, makes it possible to direct the noises produced or intensified within the hollow body of the device to various locations in or around the motor vehicle. The arrangement provides for a wide variety of possibilities for changing the way in which noise is produced for the occupants of the motor vehicle, for example in dependence on the type of vehicle or the wishes of the purchaser of the vehicle.

Noise or signal intensification is achieved according to the invention by the branch lines leading to different locations, which also provides for a three-dimensional sound.

The invention will be described below on the basis of an exemplary embodiment with reference to the accompanying drawing.

### BRIEF DESCRIPTION OF THE DRAWING

The single FIGURE shows schematically the device according to the invention for establishing noise in a vehicle.

### DESCRIPTION OF A PARTICULAR EMBODIMENT

Attached to a gas-carrying line 1 of an only schematically represented internal combustion engine 2, that is for example to an intake line or an exhaust line, via an inlet line 3, is a device 4 for transmitting the noise of the engine 2, to the vehicle interior. The basic construction and operating mode of such a device is known for example from DE 100 42 012 A1. Like the gas-carrying line 1, the engine 2, the inlet line 3 and the device 4 are located in a motor vehicle, which is not represented in its entirety. The device is capable of influencing both the noise in an interior space 5 of the motor vehicle and in the surroundings of the same.

For this purpose, the device 4 has a housing 6, which is divided by a sound transmission device, formed in the present case as a vibratable, gas-impermeable membrane 7, into two spaces, namely an inlet space 8 and an outlet space 9. The inlet space 8 is in this case connected to the inlet line 3, whereas the outlet space 9 is connected to an outlet line 10. The noises induced in the gas-carrying line 1 by pressure waves or pressure differences are introduced via the inlet line 3 into the inlet space 8 of the housing 6, whereby the membrane 7 is acted on and induced to vibrate. When acted on in this way, the membrane 7 vibrates with a typical natural frequency, which is passed on by the air located in the outlet space 9 to the outlet line 10. As already mentioned, the membrane 7 consists of a gas-impermeable material, in order to prevent passage of gases from the gas-carrying line 1 into the outlet line 10.

The outlet line 10 has a branching area 11, from which in the present case two branch lines 12 and 13 continue to the interior space 5 of the motor vehicle. As a result, it is possible to direct the described vibrations of the sound transmission device or membrane 7 to a number of locations in the interior space 5 of the motor vehicle. The two branch lines 12 and 13 may also extend to a space surrounding the vehicle, in a way not shown. The locations at which the branch lines 12 and 13 open out into the interior space 5 may be, for example, the driver footwell and the passenger footwell, whereby it is ensured that the driver and the passenger perceive the same impression of the sound.

In this way, a three-dimensional noise which depends on the operating noise of the engine 2 is established in the interior space 5 of the motor vehicle and provides to the driver of the motor vehicle acoustic information concerning the load state of the engine 2 and at the same time conveys a three-dimensional perception of the engine sound. In this connection, it is also possible for a greater number of branch lines to branch away from the branch area 11 and/or for a greater number of branch lines 11 to be provided in the outlet line 10.

At the outlet of the two branch lines 12 and 13, that is in the present case at the transition of the same into the interior vehicle space 5, there are in each case absorption materials 14 and 15, which provide for a change in the sound pattern by adding an acoustic impedance.

Furthermore, in the exemplary embodiment represented, the two branch lines 12 and 13 are of different lengths, which leads to interferences in the two branch lines 12 and 13, whereby different interference patterns are created and individual frequencies of the noises transmitted through the outlet line 10 are reduced and others are intensified.

1. A device for establishing noise in a motor vehicle, comprising a housing (4), which is divided by at least one sound transmission device (7) into at least two spaces (8, 9), an inlet line (3) interconnecting one space (8) with a gas carrying part of an internal combustion engine of the vehicle and an outlet line (10) acoustically coupling the other space (9) to at least one of an interior space of the vehicle arid the space surrounding the vehicle, said outlet line (10) having at least one branch area (11), from which at least two branch lines (12, 13) extend to different locations in at least one of the interior space (5) and the space surrounding the vehicle.

2. The device as claimed in claim 1, wherein an absorption material (14, 15) is arranged at the transition of at least one branch line (12, 13) to at least one of the interior space (5) of the vehicle and the space surrounding the vehicle.

3. The device as claimed in claim 1, wherein the branch lines (12, 13) have such different lengths that, as a result of an interference produced thereby, individual frequencies of the noises transmitted through the output line (10) are dampened and others are intensified.

4. The device as claimed in claim 1, wherein two branch lines (12, 13) are provided, one of which leads to a driver's footwell and the other of which leads to a passenger's footwell.
